(19) United States
(12) Patent Application Publication
(10) Pub. No.: US 2023/0080007 A1
(43) Pub. Date: Mar. 16, 2023

(54) FREE COOLING SYSTEM FOR HVAC SYSTEM

(71) Applicant: Johnson Controls Tyco IP Holdings LLP, Milwaukee, WI (US)

(72) Inventor: William Leslie Kopko, Jacobus, PA (US)

(21) Appl. No.: 17/800,783

(22) PCT Filed: Feb. 26, 2021
(86) PCT No.: PCT/US2021/020005

§ 371 Date: Aug. 18, 2022

Related U.S. Application Data
(60) Provisional application No. 62/981,945, filed on Feb. 26, 2020.

(51) Int. Cl. F24F 11/64; F24F 11/65; F24F 11/85; F24F 3/00; F24F 5/00; F25B 25/00

(52) U.S. Cl. CPC F24F 11/64; F24F 11/65; F24F 11/85; F24F 3/001; F24F 5/001; F25B 25/005

(57) ABSTRACT

A heating, ventilating, and/or air conditioning (HVAC) system includes a variable speed pump configured to direct a chilled fluid through a free cooling circuit of the HVAC system. The free cooling circuit is configured to place the chilled fluid in a heat exchange relationship with ambient air. The HVAC system also includes a heat exchanger configured to place the chilled fluid in a heat exchange relationship with a conditioning fluid and a controller configured to operate the variable speed pump based on a parameter of the HVAC system.

### CROSS REFERENCE TO RELATED APPLICATION

This application claims priority from and the benefit of U.S. Provisional Application Ser. No. 62/981,945, entitled “FREE COOLING SYSTEM FOR HVAC SYSTEM,” filed Feb. 26, 2020, which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Chiller systems, or vapor compression systems, utilize a working fluid (e.g., a refrigerant) that changes phases between vapor, liquid, and combinations thereof, in response to exposure to different temperatures and pressures within components of the chiller system. The chiller system may place the working fluid in a heat exchange relationship with a conditioning fluid (e.g., water) and may deliver the conditioning fluid to conditioning equipment and/or a conditioned environment serviced by the chiller system. In such applications, the conditioning fluid may be passed through downstream equipment, such as air handlers, to condition other fluids, such as air in a building.

In certain chiller systems, ambient air may additionally or alternatively be used to cool the conditioning fluid. For instance, a chiller system may include a free cooling circuit through which a chilled fluid may flow. The chilled fluid may be cooled by the ambient air, and the free cooling circuit may include a heat exchanger that places the cooled chilled fluid in a heat exchange relationship with the conditioning fluid to transfer heat from the conditioning fluid to the cooled chilled fluid. Thus, the free cooling circuit may provide cooling capabilities for the chiller system via ambient air. However, in conventional chillers, it may be difficult to control an amount of cooling provided by the free cooling circuit.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a heating, ventilating, and/or air conditioning (HVAC) system includes a variable speed pump configured to direct a chilled fluid through a free cooling circuit of the HVAC system. The free cooling circuit is configured to place the chilled fluid in a heat exchange relationship with ambient air. The HVAC system also includes a heat exchanger configured to place the chilled fluid in a heat exchange relationship with a conditioning fluid and a controller configured to operate the variable speed pump based on a parameter of the HVAC system.

In one embodiment, an air-cooled chiller system includes a free cooling circuit having a variable speed pump and a heat exchanger. The variable speed pump is configured to direct a chilled fluid through the free cooling circuit, the heat exchanger is configured to place the chilled fluid in a heat exchange relationship with a conditioning fluid, and the free cooling circuit is configured to place the chilled fluid in a heat exchange relationship with ambient air. The air-cooled chiller system also includes a controller configured to selectively operate the free cooling circuit in a first operating mode or a second operating mode based on a parameter of the air-cooled chiller system. The controller is configured to establish a threshold speed of the variable speed pump in the first operating mode.

In one embodiment, a chiller system includes a free cooling circuit comprising a variable speed pump configured to direct a chilled fluid through the free cooling circuit, and the free cooling circuit is configured to place the chilled fluid in a heat exchange relationship with ambient air. The chiller system also includes a conditioning fluid circuit having a conditioning fluid pump configured to direct a conditioning fluid through the conditioning fluid circuit, a heat exchanger configured to place the chilled fluid in a heat exchange relationship with the conditioning fluid, and a controller configured to operate the free cooling circuit based on a parameter indicative of a temperature of the free cooling circuit.

### DRAWINGS

Various aspects of this disclosure may be better understood upon reading the following detailed description and upon reference to the drawings in which:

FIG. 1 is a perspective view of a building that may utilize an embodiment of a heating, ventilation, and/or air conditioning (HVAC) system in a commercial setting, in accordance with an aspect of the present disclosure;

FIG. 2 is a schematic of an embodiment of a vapor compression system, in accordance with an aspect of the present disclosure;

FIG. 3 is a schematic of an embodiment of an HVAC system having a vapor compression system and a free cooling circuit, in accordance with an aspect of the present disclosure; and

FIG. 4 is a flowchart of an embodiment of a method or process for operating a free cooling circuit of an HVAC system, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure relate to a heating, ventilation, and/or air conditioning (HVAC) system configured to cool a conditioning fluid. For example, the HVAC system may receive the conditioning fluid from a structure (e.g., a building) and may cool the conditioning fluid. The HVAC system may then return the cooled conditioning fluid to the structure. In certain embodiments, the HVAC system may include a vapor compression system configured to cool a refrigerant and to place the cooled refrigerant in a heat exchange relationship with the conditioning fluid to absorb heat or thermal energy from the conditioning fluid. Thus, the vapor compression system may cool the conditioning fluid. The HVAC system may additionally or alternatively include a chilled fluid circuit (e.g., free cooling circuit) configured to cool a chilled fluid (e.g., ethylene glycol, propylene glycol, water, glycol-water solution) and to place the cooled chilled fluid in a heat exchange relationship with the conditioning fluid to absorb heat from the conditioning fluid. For instance, the free cooling circuit may cool the chilled fluid by transferring heat from the chilled fluid to ambient air. In this way, the cooling capacity of the free cooling circuit may be dependent on a temperature of the ambient air.

In some circumstances, it may be undesirable to excessively cool the conditioning fluid. As an example, if the conditioning fluid is water, it may not be desirable to cool the water to the point of freezing. As another example, if the conditioning fluid is a viscous fluid, it may not be desirable to cool the conditioning fluid below a particular temperature that would substantially increase the viscosity of the conditioning fluid and affect the flow (e.g., a volumetric flow rate) of the conditioning fluid. However, it may be difficult to operate the HVAC system, such as the free cooling circuit, to avoid excessively cooling the conditioning fluid. For example, it may be difficult to direct the chilled fluid through the free cooling circuit in a manner that avoids transferring too much heat from the conditioning fluid to the chilled fluid. Additionally or alternatively, multiple valves, tubing, and/or other components may be implemented to control a flow of the chilled fluid through the free cooling circuit to avoid excessively cooling the conditioning fluid. As such, a complexity and/or a cost associated with the operation and/or the manufacture of the HVAC system may be increased.

It is presently recognized that there is a need to improve the operation of the HVAC system to avoid excessively cooling the conditioning fluid. Accordingly, embodiments of the present disclosure are directed to operating a chilled fluid circuit, such as a free cooling circuit, to limit and/or otherwise control a cooling capacity of the chilled fluid circuit. By way of example, the chilled fluid circuit may include a pump that directs the chilled fluid through the chilled fluid circuit. The pump may be a variable speed pump configured to operate at different speeds to direct the chilled fluid at different flow rates through the chilled fluid circuit. For instance, increasing the speed of the pump may increase the flow rate of the chilled fluid and may cause a greater amount of heat to transfer from the conditioning fluid to the chilled fluid. Accordingly, increasing the speed of the pump may increase the cooling capacity of the chilled fluid circuit. As such, the speed of the variable speed pump may be controlled or regulated based on a desirable cooling capacity of the chilled fluid circuit. In some embodiments, a threshold speed of the pump may be determined or defined, and the pump may be operated at a speed below the threshold speed, thereby directing the chilled fluid at a desired flow rate to avoid excessively cool the conditioning fluid. Although the present disclosure primarily discusses directing chilled fluid at different speeds for an HVAC system (e.g., an HVAC system configured to cool the chilled fluid with ambient air via a free cooling circuit), the techniques described herein may be applied to any suitable system, process, or application in which it is desirable to avoid excessive cooling (e.g., to avoid freezing) of the chilled fluid, such as in process cooling applications and/or in heat recovery applications.

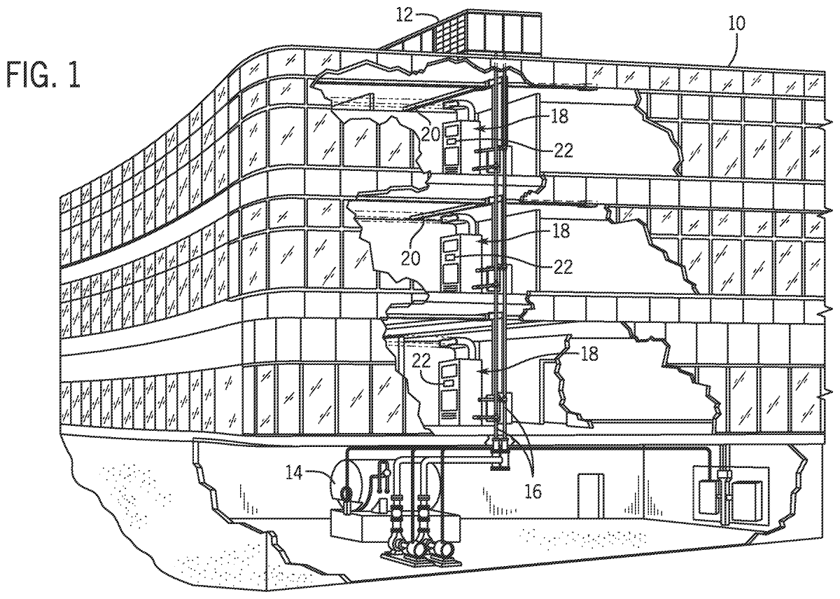

Turning now to the drawings, FIG. 1 is a perspective view of an embodiment of an application for a heating, ventilation, and air conditioning (HVAC) system. Such systems, in general, may be applied in a range of settings, both within the HVAC field and outside of that field. The HVAC systems may provide cooling to data centers, electrical devices, freezers, coolers, or other environments through vapor-compression refrigeration, absorption refrigeration, or thermoelectric cooling. In presently contemplated applications, however, HVAC systems may be used in residential, commercial, light industrial, industrial, and in any other application for heating or cooling a volume or enclosure, such as a residence, building, structure, and so forth. Moreover, the HVAC systems may be used in industrial applications, where appropriate, for basic cooling and heating of various fluids.

The illustrated embodiment shows an HVAC system for building environmental management that may utilize heat exchangers. A building 10 is cooled by a system that includes a chiller 12 and a boiler 14. As shown, the chiller 12 is disposed on the roof of building 10, and the boiler 14 is located in the basement; however, the chiller 12 and boiler 14 may be located in other equipment rooms or areas next to the building 10. The chiller 12 may be an air cooled or water cooled device that implements a refrigeration cycle to cool water or other conditioning fluid. The chiller 12 is housed within a structure that includes a refrigeration circuit, a free cooling system, and associated equipment such as pumps, valves, and piping. For example, the chiller 12 may be single package rooftop unit that incorporates a free cooling system. The boiler 14 is a closed vessel in which water is heated. The water from the chiller 12 and the boiler 14 is circulated through the building 10 by water conduits 16. The water conduits 16 are routed to air handlers 18 located on individual floors and within sections of the building 10.

The air handlers 18 are coupled to ductwork 20 that is adapted to distribute air between the air handlers 18 and may receive air from an outside intake (not shown). The air handlers 18 include heat exchangers that circulate cold water from the chiller 12 and hot water from the boiler 14 to provide heated or cooled air to conditioned spaces within the building 10. Fans within the air handlers 18 draw air through the heat exchangers and direct the conditioned air to environments within building 10, such as rooms, apartments, or offices, to maintain the environments at a designated temperature. A control device, shown here as including a thermostat 22, may be used to designate the temperature of the conditioned air. The control device 22 also may be used to control the flow of air through and from the air handlers 18. Other devices may be included in the system, such as control valves that regulate the flow of water and pressure and/or temperature transducers or switches that sense the temperatures and pressures of the water, the air, and so forth. Moreover, control devices may include computer systems that are integrated with or separate from other building control or monitoring systems, and even systems that are remote from the building 10.

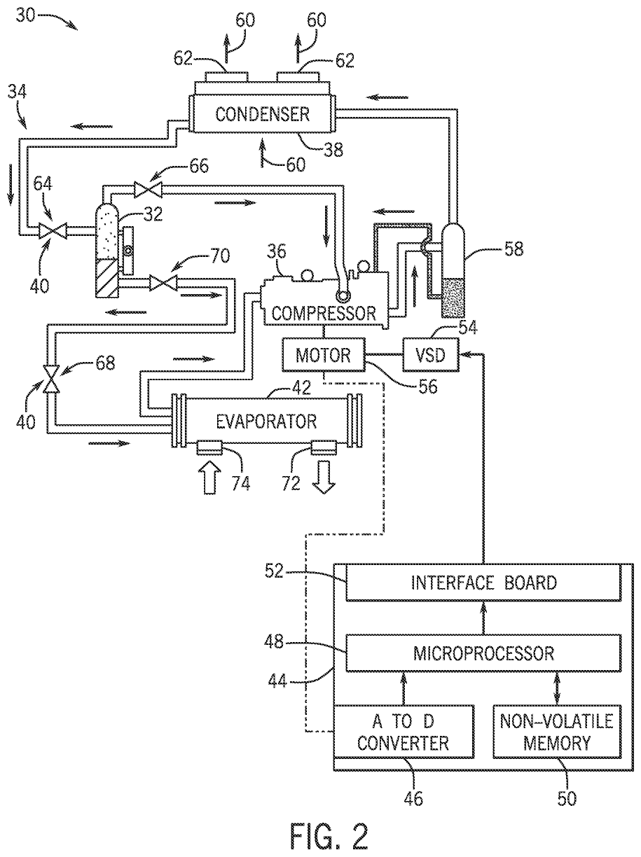

FIG. 2 is a schematic of an embodiment of a vapor compression system 30 having a flash tank 32 (e.g., economizer tank). For example, the vapor compression system 30 may be a part of an air-cooled chiller. However, it should be appreciated that the disclosed techniques may be incorporated with a variety of other types of chillers. The vapor compression system 30 includes a refrigerant circuit 34 configured to circulate a working fluid, such as refrigerant, therethrough with a compressor 36 (e.g., a screw compressor) disposed along the refrigerant circuit 34. The refrigerant circuit 34 also includes the flash tank 32, a condenser 38, expansion valves or devices 40, and a liquid chiller or an evaporator 42. The components of the refrigerant circuit 34 enable heat transfer between the working fluid and other fluids (e.g., a conditioning fluid, air, water, etc.) in order to provide cooling to an environment, such as an interior of the building 10.

Some examples of working fluids that may be used as refrigerants in the vapor compression system 30 are hydrofluorocarbon (HFC) based refrigerants, for example, R-410A, R-407, R-134a, hydrofluoro-olefin (HFO), “natural” refrigerants like ammonia (NH3), R-717, carbon dioxide (CO2), R-744, or hydrocarbon based refrigerants, water vapor, refrigerants with low global warming potential (GWP), or any other suitable refrigerant. In some embodiments, the vapor compression system 30 may be configured to efficiently utilize refrigerants having a normal boiling point of about 19 degrees Celsius (66 degrees Fahrenheit or less) at one atmosphere of pressure, also referred to as low pressure refrigerants, versus a medium pressure refrigerant, such as R-134a. As used herein, “normal boiling point” may refer to a boiling point temperature measured at one atmosphere of pressure.

The vapor compression system 30 may further include a control panel 44 (e.g., controller) that has an analog to digital (A/D) converter 46, a microprocessor 48, a non-volatile memory 50, and/or an interface board 52. In some embodiments, the vapor compression system 30 may use one or more of a variable speed drive (VSDs) 54 and a motor 56. The motor 56 may drive the compressor 36 and may be powered by the VSD 54. The VSD 54 receives alternating current (AC) power having a particular fixed line voltage and fixed line frequency from an AC power source, and provides power having a variable voltage and frequency to the motor 56. In other embodiments, the motor 56 may be powered directly from an AC or direct current (DC) power source. The motor 56 may include any type of electric motor that can be powered by the VSD 54 or directly from an AC or DC power source, such as a switched reluctance motor, an induction motor, an electronically commutated permanent magnet motor, or another suitable motor.

The compressor 36 compresses a refrigerant vapor and may deliver the vapor to an oil separator 58 that separates oil from the refrigerant vapor. The refrigerant vapor is then directed toward the condenser 38, and the oil is returned to the compressor 36. The refrigerant vapor delivered to the condenser 38 may transfer heat to a cooling fluid at the condenser 38. For example, the cooling fluid may be ambient air 60 forced across heat exchanger coils of the condenser 38 by condenser fans 62. The refrigerant vapor may condense to a refrigerant liquid in the condenser 38 as a result of thermal heat transfer with the cooling fluid (e.g., the ambient air 60).

The liquid refrigerant exits the condenser 38 and then flows through a first expansion device 64 (e.g., expansion device 40, electronic expansion valve, etc.). The first expansion device 64 may be a flash tank feed valve configured to control flow of the liquid refrigerant to the flash tank 32. The first expansion device 64 is also configured to lower the pressure of (e.g., expand) the liquid refrigerant received from the condenser 38. During the expansion process, a portion of the liquid may vaporize, and thus, the flash tank 32 may be used to separate the vapor from the liquid received from the first expansion device 64. Additionally, the flash tank 32 may provide for further expansion of the liquid refrigerant because of a pressure drop experienced by the liquid refrigerant when entering the flash tank 32 (e.g., due to a rapid increase in volume experienced when entering the flash tank 32).

The vapor in the flash tank 32 may exit and flow to the compressor 36. For example, the vapor may be drawn to an intermediate stage or discharge stage of the compressor 36 (e.g., not the suction stage). A valve 66 (e.g., economizer valve, solenoid valve, etc.) may be included in the refrigerant circuit 34 to control flow of the vapor refrigerant from the flash tank 32 to the compressor 36. In some embodiments, when the valve 66 is open (e.g., fully open), additional liquid refrigerant within the flash tank 32 may vaporize and provide additional subcooling of the liquid refrigerant within the flash tank 32. The liquid refrigerant that collects in the flash tank 32 may be at a lower enthalpy than the liquid refrigerant exiting the condenser 38 because of the expansion in the first expansion device 64 and/or the flash tank 32. The liquid refrigerant may flow from the flash tank 32, through a second expansion device 68 (e.g., expansion device 40, an orifice, etc.), and to the evaporator 42. In some embodiments, the refrigerant circuit 34 may also include a valve 70 (e.g., drain valve) configured to regulate flow of liquid refrigerant from the flash tank 32 to the evaporator 42. For example, the valve 70 may be controlled (e.g., via the control panel 44) based on an amount of suction superheat of the refrigerant.

The liquid refrigerant delivered to the evaporator 42 may absorb heat from a conditioning fluid, which may or may not be the same cooling fluid used in the condenser 38. The liquid refrigerant in the evaporator 42 may undergo a phase change to become vapor refrigerant. For example, the evaporator 42 may include a tube bundle fluidly coupled to a supply line 72 and a return line 74 that are connected to a cooling load. The conditioning fluid of the evaporator 42 (e.g., water, oil, calcium chloride brine, sodium chloride brine, or any other suitable fluid) enters the evaporator 42 via the return line 74 and exits the evaporator 42 the via supply line 72. The evaporator 42 may reduce the temperature of the conditioning fluid in the tube bundle via thermal heat transfer with the refrigerant so that the conditioning fluid may be utilized to provide cooling for a conditioned environment. The tube bundle in the evaporator 42 can include a plurality of tubes and/or a plurality of tube bundles. In any case, the refrigerant vapor exits the evaporator 42 and returns to the compressor 36 by a suction line to complete the refrigerant cycle.

In some circumstances, it may be desirable to cool the conditioning fluid via a chilled fluid circuit, such as a free cooling circuit. As used herein, free cooling refers to cooling (e.g., cooling the conditioning fluid) without operation of a vapor compression system (e.g., the vapor compression system 30). In some embodiments, free cooling operation may utilize a temperature of ambient air to cool the conditioning fluid. For example, a chilled fluid (e.g., a chilled liquid) may be cooled by the ambient air, and the cooled chilled fluid may be placed in a heat exchange relationship with the conditioning fluid to cool the conditioning fluid. In certain implementations, a free cooling system may be operated instead of the vapor compression system (e.g., the vapor compression system 30) to reduce a cost of operation. For instance, by operating the free cooling system, components of the vapor compression system, such as the compressor, may not be in operation, thereby reducing the cost associated with operating the vapor compression system and the overall HVAC system. Additionally or alternatively, the free cooling system may be used in conjunction with the vapor compression system to provide additional cooling to the conditioning fluid. Indeed, the free cooling system and the vapor compression system may be independently operable based on the desired amount of cooling of the conditioning fluid. While the embodiments discussed below describe the present techniques implemented with a free cooling circuit, it should be noted that presently-disclosed techniques may be utilized with other types of chilled fluid circuits (e.g., a vapor compression circuit).

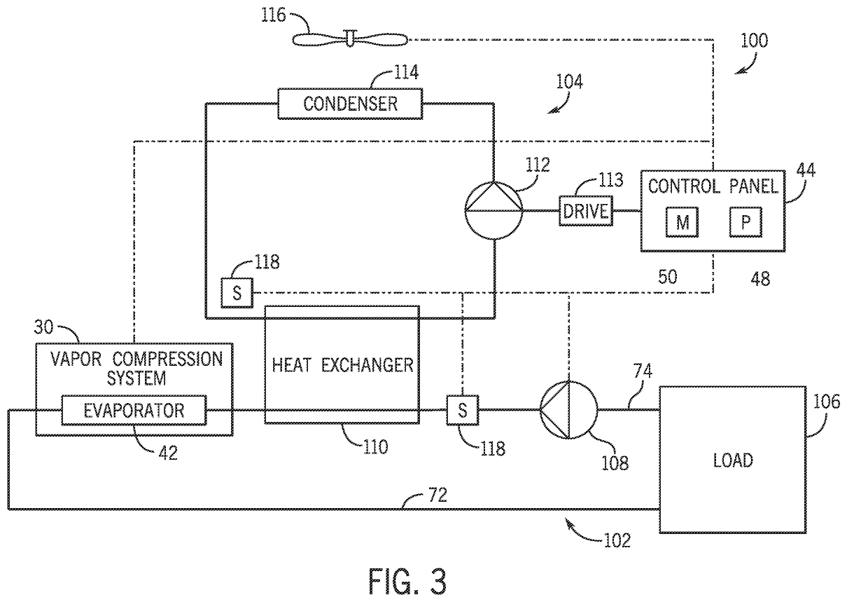

With this in mind, FIG. 3 is a schematic view of an HVAC system 100 (e.g., an air-cooled chiller system) having the vapor compression system 30, a conditioning fluid circuit 102, and a free cooling circuit 104 (e.g., a chilled fluid circuit). A conditioning fluid, such as water, may be directed through the conditioning fluid circuit 102 to be cooled by the HVAC system 100. For example, the conditioning fluid circuit 102 is fluidly coupled to a load 106, such as air handling equipment located in a part of a structure serviced by the HVAC system 100, and the HVAC system 100 may receive conditioning fluid from the load 106, cool the conditioning fluid, and return the cooled conditioning fluid to the load 106 to provide cooling for the load 106.

The conditioning fluid circuit 102 may include a conditioning fluid pump 108 positioned at the return line 74, and the conditioning fluid pump 108 may force or draw the conditioning fluid from the load 106 into the conditioning fluid circuit 102. The conditioning fluid pump 108 may direct the conditioning fluid to a heat exchanger 110, which places the conditioning fluid in a heat exchange relationship with a chilled fluid (e.g., a chilled liquid) flowing through the free cooling circuit 104. For instance, the heat exchanger 110 may enable heat transfer from the conditioning fluid to the chilled fluid, thereby cooling the conditioning fluid. The cooled conditioning fluid may then be directed from the heat exchanger 110 to the evaporator 42 of the vapor compression system 30, which may place the conditioning fluid in a heat exchange relationship with cool refrigerant and further cool the conditioning fluid. As such, implementation and operation of both the free cooling circuit 104 and the vapor compression system 30 may increase the cooling capacity provided by the HVAC system 100 to cool the conditioning fluid. However, it should be noted that in some cases, neither of or one of the free cooling circuit 104 or the vapor compression system 30 may be in operation based on a desirable amount of cooling to be provided by the HVAC system 100 (e.g., to cool the conditioning fluid). In any case, the conditioning fluid is then directed from the evaporator 42 to the load 106 via the supply line 72.

The free cooling circuit 104 may include a chilled fluid pump 112 configured to direct the chilled fluid through the free cooling circuit 104. As an example, the chilled fluid pump 112 may direct the chilled fluid to a condenser 114 (e.g., a fluid cooling coil, liquid cooling coil, etc.) of the free cooling circuit 104. The condenser 114 may cool the chilled fluid by transferring heat from the chilled fluid to ambient air. For example, the condenser 114 may be a fluid-air heat exchanger (e.g., a liquid to air heat exchanger) configured to place liquid chilled fluid (e.g., ethylene glycol, propylene glycol, water, glycol-water solution) directed through the free cooling circuit 104 in a heat exchange relationship with the ambient air. Thus, the liquid chilled fluid may be further cooled within the condenser 114 via ambient air. It should be noted that, as the chilled fluid may enter the condenser 114 as a liquid, the condenser 114 may further cool the chilled fluid without changing a phase of the chilled fluid (e.g., without condensation). Although the chilled fluid pump 112 is positioned to receive the chilled fluid from the heat exchanger 110 in the illustrated embodiment, the chilled fluid pump 112 may be disposed at any suitable position in the free cooling circuit 104, such as at a position that enables the chilled fluid pump 112 to receive the chilled fluid from the condenser 114 (e.g., to enable greater liquid flow through the chilled fluid pump 112 in embodiments in which the condenser 114 causes condensation of the chilled fluid). Further, in some embodiments, the free cooling circuit 104 may include an expansion device (e.g., an expansion tank, an expansion vent) configured to receive the chilled fluid from the condenser 114 and to depressurize and thermally expand the chilled fluid, thereby further cooling the chilled fluid.

In some embodiments, the condenser 114 may include a fan 116 configured to direct the ambient air across the condenser 114, and the chilled fluid may therefore be cooled via convection. The cooled chilled fluid may then be directed from the condenser 114 to the heat exchanger 110, where the cooled chilled fluid may absorb heat or thermal energy from the conditioning fluid to cool the conditioning fluid. The chilled fluid pump 112 may then direct the chilled fluid from the heat exchanger 110 to the condenser 114 to complete the flow path of the chilled fluid.

In certain embodiments, a substantial portion of the free cooling circuit 104 may be located in an ambient environment to place the chilled fluid in a heat exchange relationship throughout the free cooling circuit 104. In this manner, the chilled fluid within the free cooling circuit 104 may continue to be cooled by ambient air even when the chilled fluid is not in the condenser 114, thereby increasing the capacity of the chilled fluid to absorb heat from the conditioning fluid via the heat exchanger 110. As a result, the cooling capacity provided by the HVAC system 100 may be increased.

The control panel 44 may be configured to control various components of the HVAC system 100. As an example, the control panel 44 may be communicatively coupled to the chilled fluid pump 112 (e.g., a motor drive 113 of the chilled fluid pump 112) to regulate the flow of chilled fluid through the free cooling circuit 104. For instance, if operation of the free cooling circuit 104 is not desirable (e.g., if the temperature of ambient air exceeds the temperature of the conditioning fluid by a threshold temperature value), the control panel 44 may suspend or end operation of the chilled fluid pump 112. As such, chilled fluid does not flow through the free cooling circuit 104 and may not be cooled via the condenser 114. Thus, the chilled fluid in the heat exchanger 110 may not absorb heat from the conditioning fluid, and the free cooling circuit 104 therefore does not cool the conditioning fluid. In certain embodiments, the chilled fluid pump 112 may be a variable speed pump, and the motor drive 113 may be a VSD that may operate the chilled fluid pump 112 at different speeds in order to direct the chilled fluid through the free cooling circuit 104 at different flow rates. By way of example, increasing the speed of the chilled fluid pump 112 may increase the flow rate of the chilled fluid through the condenser 114 and through the heat exchanger 110 to increase heat transfer between the chilled fluid and the conditioning fluid, thereby increasing the amount of cooling provided by the chilled fluid and the free cooling circuit 104 to cool the conditioning fluid. Reducing the speed of the chilled fluid pump 112 may reduce the flow rate of the chilled fluid through the condenser 114 and through the heat exchanger 110 to reduce heat transfer between the chilled fluid and the conditioning fluid, thereby reducing the amount of cooling provided by the free cooling circuit 104 to cool the conditioning fluid. In this way, the control panel 44 may cause the chilled fluid pump 112 to operate at a particular speed based on a desirable cooling capacity of the free cooling circuit 104, such as based on a current and/or a target temperature of the conditioning fluid.

In additional or alternative embodiments, the control panel 44 may be communicatively coupled to the fan 116 to control the cooling of the chilled fluid in the condenser 114. In certain implementations, the fan 116 may be a single speed fan. Thus, the control panel 44 may operate the fan 116 to enable convection cooling of the chilled fluid in the condenser 114, or the control panel 44 may suspend operation of the fan 116 such that convection cooling is not used to cool the chilled fluid. Additionally or alternatively, the fan 116 may be a variable speed fan, and the control panel 44 may operate the fan 116 at a particular speed of multiple available speeds to direct ambient air across the condenser 114 at a desirable flow rate. In this manner, the control panel 44 may operate the fan 116 to provide a desirable cooling capacity of the chilled fluid.

It should be noted that the illustrated free cooling circuit 104 may enable desirable control of the cooling of the conditioning fluid without implementation of additional components. For example, the control panel 44 may operate the chilled fluid pump 112 and the fan 116 to control the cooling capacity without additional piping (e.g., a fluid line to bypass flow through the condenser 114), valves, pumps, or other suitable equipment. Indeed, the illustrated free cooling circuit 104 includes a single fluid loop through which the chilled fluid is directed.

The control panel 44 may also be communicatively coupled to the vapor compression system 30. For instance, the control panel 44 may be configured to control the operation of the vapor compression system 30 (e.g., by operating the compressor 36) to determine, select, establish, or set the cooling capacity of the refrigerant to cool the conditioning fluid via the evaporator 42. Further, the control panel 44 may independently operate the vapor compression system 30 and the free cooling circuit 104. In an example, the control panel 44 may operate the free cooling circuit 104 and suspend operation of the vapor compression system 30, such as when the temperature of the chilled fluid is lower than the temperature of the conditioning fluid (e.g., when the temperature of ambient air is sufficiently low), and the free cooling circuit 104 may therefore adequately cool the conditioning fluid to satisfy the demand of the load 106. As a result, the free cooling circuit 104 alone may cool the conditioning fluid. In another example, the control panel 44 may operate the vapor compression system 30 and suspend operation of the free cooling circuit 104, such as when the temperature of the chilled fluid is higher than the temperature of the conditioning fluid (e.g., when the temperature of ambient air is high), and the free cooling circuit 104 may therefore not be able to adequately cool the conditioning fluid. In a further example, the control panel 44 may operate both the free cooling circuit 104 and the vapor compression system 30, and the conditioning fluid may be cooled by both the chilled fluid of the free cooling circuit 104 and the refrigerant of the vapor compression system 30. As such, the cooling of the conditioning fluid may be increased as compared to operating the free cooling circuit 104 or the vapor compression system 30 alone. The control panel 44 may also regulate the respective operating parameters of the vapor compression system 30 and the free cooling circuit 104. That is, for example, the control panel 44 may operate the chilled fluid pump 112 of the free cooling circuit 104 independently of the compressor 36 of the vapor compression system 30. In this way, the control panel 44 may change the respective cooling capacities of the vapor compression system 30 and the free cooling circuit 104.

The control panel 44 may further be communicatively coupled to the conditioning fluid pump 108. As an example, the control panel 44 may operate the conditioning fluid pump 108 to direct conditioning fluid through the conditioning fluid circuit 102 based on a determination by the control panel 44 that cooling of the conditioning fluid is desirable (e.g., based on a demand of the load 106). The control panel 44 may alternatively suspend operation of the conditioning fluid pump 108 when cooling of the conditioning fluid is not desirable and therefore, the conditioning fluid is not directed through the conditioning fluid circuit 102. In certain embodiments, the conditioning fluid pump 108 may be a variable speed pump, and the control panel 44 may operate the conditioning fluid pump 108 to direct conditioning fluid through the conditioning fluid circuit 102 at a particular flow rate of multiple available flow rates. For instance, if an increased amount (e.g., an increased volumetric flow rate) of the conditioning fluid is desirable, the control panel 44 may increase the speed of the conditioning fluid pump 108 to increase the flow rate of the conditioning fluid through the conditioning fluid circuit 102.

As mentioned above, it may not be desirable to cool the conditioning fluid below a threshold temperature. For this reason, the control panel 44 may operate the HVAC system 100 to avoid excessive cooling of the conditioning fluid. For example, the control panel 44 may cause the chilled fluid pump 112 to operate below a threshold speed to limit the flow rate of the chilled fluid through the free cooling circuit 104, thereby limiting the cooling provided by the chilled fluid to the conditioning fluid. To this end, the control panel 44 may be communicatively coupled to one or more sensors 118 that may each monitor a parameter of the HVAC system 100. In an example, the sensor(s) 118 may be a part of the free cooling circuit 104, and the parameter may include a temperature of the chilled fluid entering the heat exchanger 110, a temperature of the condenser 114 (e.g., a temperature of a wall or shell of the condenser 114), a temperature of the chilled fluid exiting the heat exchanger 110, a temperature of the ambient air, a flow rate of the chilled fluid through the free cooling circuit 104, another suitable parameter, or any combination thereof. In an additional example, the sensor(s) 118 may be a part of the conditioning fluid circuit 102, and the parameter may include a temperature of the conditioning fluid, a flow rate of the conditioning fluid, a temperature of the evaporator 42 (e.g., a temperature of a wall or shell of the evaporator 42), a temperature of the heat exchanger 110 (e.g., a temperature of a wall or shell of the heat exchanger 110), another suitable parameter, or any combination thereof. In a further example, the control panel 44 may receive other suitable parameters, such as a desirable or target temperature of the conditioning fluid, a desirable or target flow rate of the conditioning fluid, and the like. As mentioned above, the sensor(s) 118 may determine the temperature of the chilled fluid and/or of the conditioning fluid based on a temperature of a wall or other structural component of a heat exchanger or circuit. For example, the sensor(s) 118 may determine a temperature of a conduit, tubing, coil, shell, fin, or pipe through which the chilled fluid or the conditioning fluid may flow to indicate the temperature of the chilled fluid and/or the conditioning fluid. In additional or alternative embodiments, the sensor(s) 118 may determine the temperature of the chilled fluid and/or of the conditioning fluid based on a bulk fluid temperature, such as an average (e.g., a mathematic mean) of respectively detected fluid temperatures at different locations along the respective flow paths of the fluids.

The sensor(s) 118 may transmit data indicative of the determined parameter to the control panel 44, and the control panel 44 may operate the chilled fluid pump 112 accordingly, such as by setting, determining, or defining the threshold speed of the chilled fluid pump 112. Accordingly, the motor drive 113 of the chilled fluid pump 112 may operate the chilled fluid pump 112 at any suitable speed (e.g., below a threshold speed) to avoid excessive cooling of the conditioning fluid.

Additionally or alternatively, the control panel 44 may operate another suitable component of the HVAC system 100 to avoid cooling the conditioning fluid below the threshold temperature. As an example, the control panel 44 may set, determine, or define a threshold fan speed of the fan 116 to operate the fan 116 above or below the threshold fan speed, set, determine, or define a threshold pump speed of the conditioning fluid pump 108 to operate the conditioning fluid pump 108 above or below the threshold pump speed, initiate or suspend the operation of the vapor compression system 30 and/or the free cooling circuit 104, or any combination thereof. Indeed, the control panel 44 may determine or select the operation mode and/or determine, establish or select a threshold operating parameter of any component of the HVAC system 100 to avoid excessively cooling the conditioning fluid.

In certain embodiments, the control panel 44 may reference a database table in order to select or determine the operation of the HVAC system 100 based on data transmitted by the sensor(s) 118. The database table may indicate a respective operating mode or operating parameter (e.g., a pump speed of the chilled fluid pump 112, a pump speed of the conditioning fluid pump 108, a fan speed of the fan 116, an operation of the vapor compression system 30) of the HVAC system 100 based on different combinations of the parameters determined by the sensor(s) 118. Thus, the control panel 44 may reference the database table to select the corresponding operating mode of the HVAC system 100 based on the data transmitted by the sensor(s) 118. In additional or alternative embodiments, the control panel 44 may use an equation to determine the operation of the HVAC system 100. The equation may include a relationship (e.g., a mathematical relationship) between the operating mode (e.g., a pump speed of the chilled fluid pump 112, a pump speed of the conditioning fluid pump 108, a fan speed of the fan 116, an operation of the vapor compression system 30) of the HVAC system 100 and the parameters determined by the sensor(s) 118. As such, the control panel 44 may calculate a corresponding operating mode of the HVAC system 100 by utilizing the equation.

It should be noted that the control panel 44 may change the operating mode of the HVAC system 100 at different times of the operation of the HVAC system 100. By way of example, upon initialization of the operation of the HVAC system 100, the temperature of the chilled fluid may be at a low temperature. As such, the control panel 44 may select or establish the threshold speed of the chilled fluid pump 112 as a low threshold speed to reduce the amount of heat transfer between the chilled fluid and the conditioning fluid to avoid excessively cooling the conditioning fluid. However, as the HVAC system 100 continues to operate, the temperature of the chilled fluid may increase due to the ongoing heat exchange with the conditioning fluid via the heat exchanger 110 and/or due to heat generated by the operation of the free cooling circuit 104 (e.g., by the chilled fluid pump 112). Accordingly, the cooling capacity of the chilled fluid may be reduced. Therefore, the control panel 44 may increase the threshold speed of the chilled fluid pump 112 from the low threshold speed such that the motor drive 113 may increase the operating speed of the chilled fluid pump 112 without causing excessive cooling of the conditioning fluid.

In some embodiments, the control panel 44 may initiate the operation of the HVAC system 100 in a first operating mode (e.g., a fixed or pre-determined mode) regardless of the parameters determined by the sensor(s) 118. Accordingly, the HVAC system 100 may initially operate in the same, first operating mode. For example, the first operating mode may be a low operating mode of the HVAC system 100, such as an operating mode having the low threshold speed of the chilled fluid pump 112. The particular operation in the first operating mode may be determined via testing (e.g., during development or manufacture of the HVAC system 100) and/or via analysis of previous operations of the HVAC system 100. As the HVAC system 100 continues to operate, the control panel 44 may adjust or remove the threshold speed of the chilled fluid pump 112 accordingly. In additional or alternative embodiments, upon initiating the operation of the HVAC system 100, the control panel 44 may receive data from the sensor(s) 118 before determining or selecting the operating mode of the HVAC system 100. As a result, a particular operating mode of the HVAC system 100 may not be determined or selected until a certain time interval after the operation of the HVAC system 100 has initiated. In any case, the control panel 44 may dynamically adjust the operating mode of the HVAC system 100 as the HVAC system 100 continues to operate, such as by changing the threshold speed of the chilled fluid pump 112, based on the data received by the sensor(s) 118.

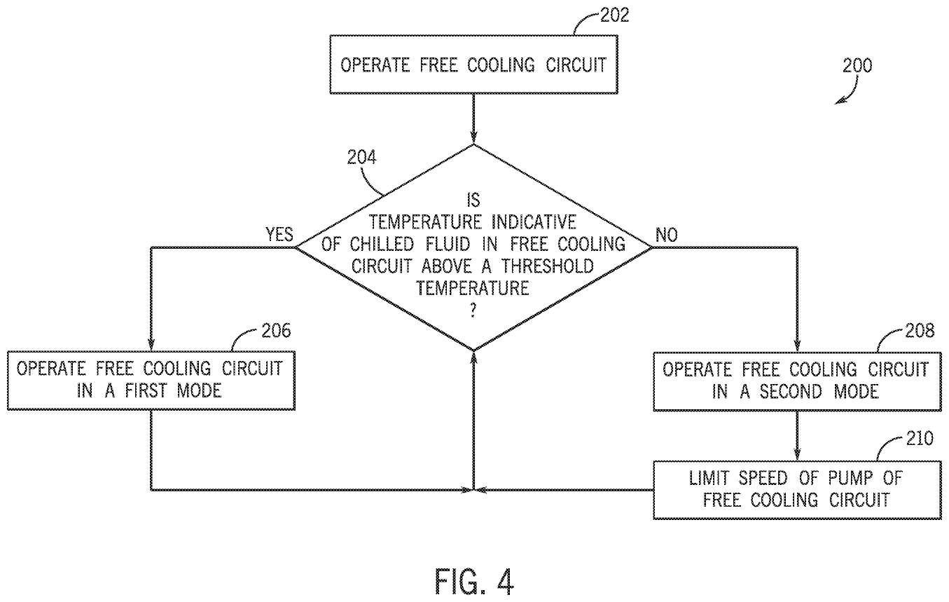

FIG. 4 is a flowchart of an embodiment of a method or process 200 for operating the free cooling circuit 104 of the HVAC system 100. In some embodiments, the method 200 may be performed by a single controller, such as the control panel 44. In additional or alternative embodiments, the method 200 may be performed by multiple controllers. Further, certain steps of the method 200 may be performed differently in different embodiments, such as a different embodiment of the HVAC system 100. For example, additional steps may be performed, and/or certain steps of the method 200 may be removed, modified, or performed in a different order.

At block 202, the free cooling circuit 104 is operated. To this end, the chilled fluid pump 112 may be in operation to direct chilled fluid through the free cooling circuit 104. In some embodiments, the free cooling circuit 104 may be operated in response to a determination that the conditioning fluid is being directed through the conditioning fluid circuit 102 (e.g., based on the flow rate of the conditioning fluid determined by the sensor(s) 118) and that ambient air may be used to cool the conditioning fluid (e.g., based on a temperature of the ambient air determined by the sensor(s) 118). For instance, the free cooling circuit 104 may operate based on a determination that the ambient air is at a sufficiently low temperature such that heat may be adequately transferred from the conditioning fluid to the chilled fluid and from the chilled fluid to the ambient air, thereby cooling the conditioning fluid. In certain embodiments, the fan 116 of the free cooling circuit 104 may also be operated to cool the chilled fluid flowing through the condenser 114 (e.g., a liquid to air heat exchanger), thereby increasing the cooling capacity of the chilled fluid.

At block 204, a determination is made regarding whether the temperature indicative of the chilled fluid in the free cooling circuit 104 is above a threshold temperature. In some embodiments, the determination regarding the temperature indicative of the chilled fluid temperature may be based on a temperature of a component of the free cooling circuit 104 (e.g., a wall or other structural component of the condenser 114). In other words, a determination is made regarding whether the chilled fluid flowing through the free cooling circuit 104 may cause excessive cooling of the conditioning fluid. As an example, the sensor(s) 118 may transmit data indicative of the current temperature of the chilled fluid flowing at a particular section of the free cooling circuit 104, such as exiting the condenser 114, entering the condenser 114, entering the heat exchanger 110, exiting the heat exchanger 110, received by the chilled fluid pump 112, flowing at any other suitable section of the free cooling circuit 104, or any combination thereof. As discussed above, the data indicative of the current temperature of the chilled fluid may be a temperature of the chilled fluid or a temperature of a component of the free cooling circuit 104.

In addition, the threshold temperature may be based on a parameter associated with the conditioning fluid directed through the conditioning fluid circuit 102, such as a low temperature, which may refer to a temperature above which the conditioning fluid is to be maintained. For example, if it is desirable to avoid freezing of the conditioning fluid (e.g., water), the threshold temperature may be above a temperature at which the conditioning fluid freezes (e.g., zero degrees Celsius). However, the threshold temperature may be any suitable temperature (e.g., a temperature at which the conditioning fluid reaches a threshold viscosity), such as five degrees Celsius, negative five degrees Celsius, negative ten degrees Celsius, and so forth. The threshold temperature may additionally or alternatively be based on any other suitable parameter, such as a current temperature of the conditioning fluid, a target temperature of the conditioning fluid, a current temperature of ambient air, a current temperature of a component of the free cooling circuit 104, a flow rate of the conditioning fluid through the conditioning fluid circuit 102, a composition of the chilled fluid, a composition of the conditioning fluid, another suitable parameter, or any combination thereof. Moreover, in additional or alternative embodiments, a threshold of any other suitable parameter of the HVAC system 100 may be used to determine whether the free cooling circuit 104 may cause excessive cooling of the conditioning fluid.

In response to a determination that the temperature indicative of the chilled fluid temperature is above the threshold temperature, the free cooling circuit 104 may be operated in a first operating mode, as shown at block 206. In the first operating mode, the chilled fluid pump 112 of the free cooling circuit 104 may be operated normally (e.g., without blocking or limiting the operating speed). Further, the fan 116 of the free cooling circuit 104 may be operated to cool the chilled fluid in the condenser 114. As such, the free cooling circuit 104 may be operated to provide a first or higher cooling capacity of the conditioning fluid in the first operating mode. For example, the free cooling circuit 104 may be operated in the first operating mode when the temperature of the ambient air and/or the temperature of the conditioning fluid is substantially greater than the low temperature of the conditioning fluid (e.g., by a first threshold temperature value). As the free cooling circuit 104 operates in the first operating mode, the temperature indicative of the chilled fluid temperature in the free cooling circuit 104 may be continuously monitored to determine whether operation of the free cooling circuit 104 in the first operating mode is to be maintained.

However, in response to a determination that the temperature indicative of the chilled fluid temperature is below the threshold temperature, the free cooling circuit 104 may be operated in a second operating mode, as shown at block 208. The second operating mode may block the free cooling circuit 104 from excessively cooling the conditioning fluid, or cooling the conditioning fluid below the low temperature. By way of example, the free cooling circuit 104 may be operated in the second operating mode when the temperature of the ambient air is substantially lower than the low temperature (e.g., by a second threshold temperature value). Additionally or alternatively, the free cooling circuit 104 may be operated in the second operating mode when the temperature of the conditioning fluid is near (e.g., not substantially above, within a third threshold temperature value of) the low temperature.

In any case, during operation in the second operating mode of the free cooling circuit 104, the speed of the chilled fluid pump 112 may be limited, as shown at block 210. By way of example, a threshold speed of the chilled fluid pump 112 may be selected or established, and the speed of the chilled fluid pump 112 may remain below the selected threshold speed. That is, the chilled fluid pump 112 may operate at any speed below the threshold speed, but operation of the chilled fluid pump 112 above the threshold speed may be blocked. Therefore, for example, the motor drive 113 may control the operation of the chilled fluid pump 112 accordingly (e.g., by changing a current speed of the chilled fluid pump 112). As a result, the chilled fluid is directed through the free cooling circuit 104 at a limited flow rate to limit the cooling capacity of the chilled fluid and avoid excessively cooling the conditioning fluid (e.g., further cooling the chilled fluid below the threshold temperature). In some implementations, the fan 116 may not be operated while the free cooling circuit 104 operates in the second operating mode so as to avoid excessively cooling the conditioning fluid. Additionally or alternatively, the fan 116 may be operated during the second operating mode of the free cooling circuit 104 under certain operating conditions, such as while the vapor compression system 30 is or is not in operation and/or while the temperature of the conditioning fluid is substantially greater than the low temperature.

The temperature indicative of the chilled fluid temperature may be continuously monitored during the operation of the free cooling circuit 104 in the second operating mode to determine whether operation in second operating mode is to be maintained. In certain embodiments, if a determination is made that the temperature indicative of the chilled fluid temperature is above the threshold temperature (e.g., above a fourth threshold temperature value above the threshold temperature), the operation of the free cooling circuit 104 may transition from the second operating mode to the first operating mode. Accordingly, the threshold speed of the chilled fluid pump 112 may be removed such that the chilled fluid pump 112 may operate at any suitable speed to direct the chilled fluid through the free cooling circuit 104, and/or the fan 116 may be operated to cool the chilled fluid. In additional or alternative embodiments, the threshold speed of the chilled fluid pump 112 may be dynamically selected or established based on the temperature indicative of the chilled fluid temperature while the free cooling circuit 104 operates in the second operating mode. That is, the threshold speed of the chilled fluid pump 112 may be adjusted (e.g., increased) as the temperature indicative of the chilled fluid temperature changes (e.g., increases). In further embodiments, the particular operation of other components of the free cooling circuit 104 (e.g., the speed of the fan 116) may be based on the temperature indicative of the chilled fluid temperature in the second operating mode of the free cooling circuit 104. Further still, other parameters in addition to or as an alternative to the temperature indicative of the chilled fluid temperature may be monitored to determine the particular operation of the components of the free cooling circuit 104 in the second operating mode.

While only certain features of present embodiments have been illustrated and described herein, many modifications and changes will occur to those skilled in the art. It is, therefore, to be understood that the appended claims are intended to cover all such modifications and changes that fall within the true spirit of the disclosure. Further, it should be understood that certain elements of the disclosed embodiments may be combined or exchanged with one another.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A heating, ventilating, and/or air conditioning (HVAC) system, comprising:
a variable speed pump configured to direct a chilled fluid through a free cooling circuit of the HVAC system, wherein the free cooling circuit is configured to place the chilled fluid in a heat exchange relationship with ambient air;
a heat exchanger configured to place the chilled fluid in a heat exchange relationship with a conditioning fluid; and
a controller configured to operate the variable speed pump based on a parameter indicative of a temperature of the HVAC system.

2. The HVAC system of claim 1, wherein the controller is configured to establish a threshold speed of the variable speed pump based on the parameter of the HVAC system.

3. The HVAC system of claim 2, wherein the parameter is indicative of a temperature of the chilled fluid, and the controller is configured to not establish the threshold speed of the variable speed pump in response to a determination that the parameter indicative of the temperature of the chilled fluid is above a threshold temperature.

4. The HVAC system of claim 1, wherein the chilled fluid comprises water, ethylene glycol, or both.

5. The HVAC system of claim 1, wherein the heat exchanger is configured to receive the chilled fluid from a cooling coil of the free cooling circuit, and the variable speed pump is configured to direct the chilled fluid from the heat exchanger to the cooling coil.

6. The HVAC system of claim 1, wherein the parameter of the HVAC system comprises a temperature of the ambient air, a flow rate of the conditioning fluid, a temperature of the conditioning fluid, a temperature of a structural component of the free cooling circuit, a composition of the chilled fluid, or any combination thereof, and the controller is configured to operate the variable speed pump at a speed based on the parameter.

7. An air-cooled chiller system, comprising:
a free cooling circuit comprising a variable speed pump and a heat exchanger, wherein the variable speed pump is configured to direct a chilled fluid through the free cooling circuit, the heat exchanger is configured to place the chilled fluid in a heat exchange relationship with a conditioning fluid, and the free cooling circuit is configured to place the chilled fluid in a heat exchange relationship with ambient air; and
a controller configured to selectively operate the free cooling circuit in a first operating mode or a second operating mode based on a parameter of the air-cooled chiller system, wherein the controller is configured to establish a threshold speed of the variable speed pump in the first operating mode.

8. The air-cooled chiller system of claim 7, wherein the controller is configured to operate the free cooling circuit in the first operating mode upon initializing operation of the free cooling circuit.

9. The air-cooled chiller system of claim 7, wherein the controller is configured to operate the variable speed pump without the threshold speed in the second operating mode of the free cooling circuit.

10. The air-cooled chiller system of claim 7, wherein the controller is configured to dynamically adjust the threshold speed of the variable speed pump based on the parameter of the air-cooled chiller system.

11. The air-cooled chiller system of claim 7, wherein the parameter of the air-cooled chiller system comprises data indicative of a temperature of the chilled fluid, the controller is configured to operate the free cooling circuit in the first operating mode in response to a determination that the data indicative of the temperature of the chilled fluid is below a threshold temperature, and the controller is configured to operate the free cooling circuit in the second operating mode in response to a determination that the data indicative of the temperature of the chilled fluid is above the threshold temperature.

12. The air-cooled chiller system of claim 11, wherein the parameter comprises a temperature of the chilled fluid entering the heat exchanger, a temperature of the chilled fluid exiting the heat exchanger, a temperature of the chilled fluid exiting a condenser of the free cooling circuit, a temperature of a structural component of the free cooling circuit, or any combination thereof.

13. The air-cooled chiller system of claim 8, wherein the free cooling circuit comprises a cooling coil configured to place the chilled fluid in the heat exchange relationship with the ambient air, the variable speed pump is configured to direct the chilled fluid from the heat exchanger to the cooling coil, and the heat exchanger is configured to receive the chilled fluid from the cooling coil.

14. The air-cooled chiller system of claim 13, comprising a fan configured to force the ambient air across the cooling coil, wherein the controller is configured to operate the fan in the second operating mode of the free cooling circuit.

15. The air-cooled chiller system of claim 14, wherein the controller is configured to suspend operation of the fan in the first operating mode of the free cooling circuit.

16. A chiller system, comprising:
a free cooling circuit comprising a variable speed pump configured to direct a chilled fluid through the free cooling circuit, wherein the free cooling circuit is configured to place the chilled fluid in a heat exchange relationship with ambient air, and the free cooling circuit comprises a single fluid loop;
a conditioning fluid circuit comprising a conditioning fluid pump configured to direct a conditioning fluid through the conditioning fluid circuit;
a heat exchanger configured to place the chilled fluid in a heat exchange relationship with the conditioning fluid; and
a controller configured to operate the free cooling circuit based on a parameter of the free cooling circuit.

17. The chiller system of claim 16, comprising a vapor compression system configured to circulate a refrigerant therethrough, wherein the vapor compression system comprises an evaporator configured to place the refrigerant in a heat exchange relationship with the conditioning fluid.

18. The chiller system of claim 17, wherein the controller is configured to operate the vapor compression system independently from the free cooling circuit.

19. The chiller system of claim 17, wherein the evaporator is configured to receive the conditioning fluid from the heat exchanger.

20. The chiller system of claim 16, wherein the controller is configured to suspend operation of the free cooling circuit in response to a determination that a temperature of the free cooling circuit exceeds a threshold temperature.
